(19) United States
(12) Patent Application Publication
(10) Pub. No.: US 2006/0169838 A1
(43) Pub. Date: Aug. 3, 2006

(54) Method of enhancing the movement of dangerous goods

(76) Inventor: Joshua William Stevens, Midland, MI (US)

Correspondence Address: MCKELLAR IP LAW, PLLC, 784 SOUTH POSEYVILLE ROAD, MIDLAND, MI, 48640, US

(21) Appl. No.: 11/371,722

(22) Filed: Mar. 9, 2006

Related U.S. Application Data
(63) Continuation of application No. 10/435,858, filed on May 12, 2003, now abandoned.

(51) Int. Cl. B64C 1/20

(52) U.S. Cl. 244/118.1

(57) ABSTRACT

A method for enhancing the efficiency of freighting dangerous goods, the method comprising utilization of wing-in-ground craft (WIG) equipped pursuant to the international maritime dangerous goods code regulating the movement of these types of material.

This application claims priority from U.S. Utility application Ser. No. 10/435,858 filed on May 12, 2003.

The invention disclosed and claimed herein deals with a method for enhancing the efficiency of freighting dangerous goods, the method comprising utilization of wing-in-ground craft (WIG) equipped pursuant to the international maritime dangerous goods code regulating the movement of these types of material.

### BACKGROUND OF INVENTION

The background of this invention deals with the ability to overcome the obstacles that exist, mainly the length of transit time in the movement of dangerous goods, globally. Under the current system the majority of dangerous goods are transported by truck and or rail to port. This leg of the journey may take a couple of days and maybe even up to a week depending on the location from which it is shipped. Once the freight arrives at port it sits waiting, either to be loaded on a container ship or waiting for that ship to arrive. After the freight is loaded on the ship, it may stop at other ports to pick-up containers or sail to the port of destination. The whole process takes on the average about six weeks if departing from the East coast of the United States to a European port. The current system is slow, costly, and inefficient. The method of this invention seeks to overcome these obstacles through the use of wing-in-ground craft equipped according to this invention.

The type A & B wing-in-ground crafts are defined by and regulated by the international maritime organization as vessels, not aircraft, as such they can transport dangerous goods as long as they are properly equipped and are in compliance with the international maritime dangerous goods code. The wing-in-ground craft as utilized in this invention are defined in the international maritime organization manual, “INTERIM GUIDELINES FOR WING-IN-GROUND (WIG) CRAFT”, Dec. 16, 2002, page 10, under section 4.45.1 and 4.45.2 The use of this type of craft to transport dangerous goods is revolutionary in many respects.

The time that it would take to move the materials from the East coast of the United States to a European port could be reduced from six weeks to less than twenty-four hours and in some cases less than ten to twelve hours and thus, the transportation of dangerous goods is enhanced.

The technology that allows these craft to travel allows a greater fuel economy than that of the container vessels, saving money in the cost of the transportation itself The economic impact of facilitating this market while expanding other markets cannot be overlooked. Markets that once found it too costly to ship goods via air or sea will have the opportunity to finally be realized. Sample shipping of dangerous goods may be a small market but because of the dangerous goods classification they have no other choice but to ship by sea. These samples are generally collected by a freight forwarder that will containerize them, adding extra delay and expense, in filling the container with the desired amount to make it economically feasible to ship. This greatly impacts imports and exports as well. The turnaround time for raw materials shipped out to return as finished product is seriously reduced allowing companies to get their products to market much quicker.

Safety is also affected by this method. The more that an item is handled the more it has a greater potential to become damaged. The environment that the containers are exposed to during transportation includes, for example, drastic climatic changes, potentially damaging the product or the packaging that could lead to spills and leakage. Under the proposed method these shipments would not spend large amounts of time in transit or awaiting departure, limiting the time that they are handled and the length of time that they are idle on a loading dock. Another safety advantage is the WIG craft can land on water; essentially it is never far away from a potential runway.

### THE INVENTION

The invention disclosed and claimed herein is a method for enhancing the efficiency of freight movement of dangerous goods comprising utilizing wing-in-ground craft equipped pursuant to the international maritime dangerous goods code. This is possible because of the aerodynamic phenomena known as surface effect. These craft fly close to the surface, wherein a wing in free flight has induced drag caused by highly pressurized air underneath the wing caused by air moving over top of the wing where the air is less pressurized. When the air moves over the wing, vortices are formed known as jetwash or downwash. When the wing gets closer to the surface the downwash is significantly reduced, how significantly reduced is the relationship between wing size and the distance of the craft from the surface. A wider wing allows a greater distance between the surface and the wing to experience surface effects. This effect allows the craft to fly with substantially lower amounts of thrust or force. Capturing and using this phenomenon is the primary idea behind wing-in-ground craft.

The inventive method allows for transportation of materials that are currently classified or restricted as dangerous goods under 49 CFR or IATA DGR. This definition is what is intended to be the meaning of dangerous goods herein. The only alternative for shipment is travel by ground and by ships at sea. The current method, by container ship can take on the average of six weeks from an East coast port to a European port. With the inventive method herein, this is reduced to less than twenty-four hours.

The inventive method creates a reduction in transit time having a significant impact on a number of economic interests. It would dramatically increase the flow of trade, in that, the expedited service allows companies to export and import goods efficiently, enhancing their business and trade. At the same time this facilitates the opening of new markets that have not been possible because of either cost or timeliness.

The inventive method also allows for a savings for the business through more cost effective transportation as opposed to the higher cost of shipping by conventional surface shipping. The surface effect technology used by wing-in-ground craft makes them much more fuel efficient. In addition, valuable inventory is not tied up on ships for weeks.

The method also promotes safety where dangerous goods are concerned. Storage and loading of containers may create many scenarios that lead to damage of container contents. The method is conducted via containerized or customized packaging similar to current methods except that it is conducted on a significantly different time table allowing for a more efficient orderly flow of dangerous goods and materials within the current scope of national and international regulations regarding the transportation of these types of material.

### DETAILED DISCRIPTION OF THE INVENTION

The method of this invention is a method for enhancing the effiency of freighting dangerous goods, the method comprising utilization of wing-in-ground craft equipped pursuant to the international maritime dangerous goods code regulating the movement of these types of materials. Transportation of dangerous goods via wing-in-ground craft focuses on current regulation and technology, in combination, to achieve a timely, efficient and safer means for freighting this cargo on a global scale.

There currently are three types of wing-in-ground craft. These are A, B and C as classified by the International Maritime Organization, “INTERIM GUIDELINES FOR WING-IN-GROUND CRAFT”, Dec. 16, 2002, page 10, under sections 4.45.1, 4.45.2 an 4.45.3. Type C is capable of sustained flight thus making it fall within an aircraft classification and therefore, making it unsuitable for the inventive method as set forth and claimed herein. However, type A and B are suitable for the intended purpose because they are classified as vessels, not air craft, by the international maritime organization and those craft are the WIG craft intended to be within the scope of this invention. Their limited flyover capabilities place them under maritime regulation. As such they are regulated by the international maritime dangerous goods code. This method will allow the transportation of these goods via wing-in-ground craft.

The interior of the craft accommodates a variety of cargo containers based on size. The design allows loading and unloading of containers onto the vessel with ease. It also has the ability to secure each container so as to keep it from moving during transportation. The interior also has to be compartmentalized to isolate non-compatible substances from interaction. The interior design of the craft is in compliance with the international maritime dangerous goods code in order to be eligible to haul dangerous goods. An area has also been developed to haul small samples. The ability to secure small packages expedites sample shipping eliminating the delay of containerizing small shipments.

What is claimed is:

1. A method of enhancing the efficiency of freight movement of dangerous goods, the method comprising utilizing wing-in-ground craft selected from the group consisting of type A and type B, equipped pursuant to the international maritime dangerous goods code, to freight such dangerous goods, the method comprising:
A) providing the wing-in-ground craft that has been equipped pursuant to the international maritime dangerous goods code,
B) loading said wing-in-ground craft with some dangerous goods, and
C) transporting the dangerous goods to a predetermined destination.
